(19) United States
(12) Patent Application Publication
(10) Pub. No.: US 2023/0195978 A1
(43) Pub. Date: Jun. 22, 2023

(54) PERFORMANCE PREDICTION METHOD AND SYSTEM FOR WHOLE ATOMIZATION PROCESS OF AEROENGINE FUEL

(71) Applicants: Taicang Yangtze Delta Research Institute, Northwestern Polytechnical University, Taicang City (CN); Beijing Institute of Aerospace System Engineering, Beijing (CN)

(72) Inventors: Fuzhen CHEN, Taicang City (CN); Hu LIU, Taicang City (CN); Hong YAN, Taicang City (CN); Xiaoqiang SUN, Taicang City (CN)

(21) Appl. No.: 17/681,482

(22) Filed: Feb. 25, 2022

(30) Foreign Application Priority Data
Dec. 16, 2021 (CN) 202111542198.2

(51) Int. Cl. G06F 30/28; G06F 30/25

(52) U.S. Cl. CPC G06F 30/28; G06F 30/25; G06F 2111/10

(57) ABSTRACT

A performance prediction method and system for a whole atomization process of an aeroengine fuel. The method includes: establishing a physical fuel-gas-droplet multiphase flow model; obtaining a central velocity field and a fluid volume fraction distribution of meshes with a finite volume method (FVM) based on the physical fuel-gas-droplet multiphase flow model; defining a gas and a liquid according to the central velocity field and the fluid volume fraction distribution; performing mesh refinement on the gas-liquid two-phase interface with an orthogonal adaptive Cartesian mesh method; transforming droplets less than a specified size in the atomization process into Lagrangian particle points; and performing calculation on different volume fractions for the Lagrangian particles included in the meshes to obtain flow field data and droplet data on different time nodes. The present disclosure has the advantages of less calculation burden, higher stability, adjustable liquid properties, trackable droplet trajectories, and so on.

This application claims priority of Chinese Patent Application No. 202111542198.2, filed on Dec. 16, 2021, which is incorporated herein by reference.

### TECHNICAL FIELD

The present disclosure relates to the technical field of aircraft performance prediction, and in particular, to a performance prediction method and system for a whole atomization process of an aeroengine fuel.

### BACKGROUND ART

Technical progresses of aeroengines are crucial to improve performance and reduce pollutant emission of aircrafts. In the field of aeroengines, combustion chambers are key components to core engines. At present, the combustion chambers of all aeroengines provide the power for aircrafts by virtue of atomization, breakup, evaporation and combustion of liquid fuels. Hence, the atomization and breakup of the liquid fuels in the combustion chambers directly affect the overall performance of the engines. During the atomization and breakup, the liquid fuels are formed into continuous rotating jets in fuel nozzles, strongly interacted with surrounding or mixing air, and formed into small evaporable droplets through primary breakup and secondary breakup; and at last the droplets are evaporated and combusted in an environment under the high temperature, high pressure and high swirling flow.

There mainly have been three methods to simulate and predict the atomization performance of the fuels:

The first method is the Eulerian meshing based on interface tracking, which is implemented by taking gas and liquid phases as continuous fluids, solving motions of the two phases with the same governing equations, and processing the interface additionally to keep the calculation stable. The method is hardly applied to numerical simulation on fuel atomization of real aeroengines, though it can accurately reproduce fluctuations on surfaces of liquid columns and liquid films and generation of the droplets.

The second method is the Lagrangian particle dynamic method based on particle trajectory tracking (such as the discrete particle model (DPM)). With the gas phase as the continuous phase, the method models the liquid phase as the Lagrangian liquid parcels or particles to simulate behaviors of droplets upon the breakup. The motion process of the droplets is decomposed into an instantaneous collision motion dominated by the impact force and a suspension motion controlled by the fluid drag, thus establishing the motion decomposition model for the droplets. This method needs to amend the breakup process of the jets in combination with experiments, with reliance on Lagrangian descriptions about spherical liquid parcels from nozzle outlets and ignorance for all details of motions on the phase interface. In spite of the less computational burden, it neither describes the real process of the jet breakup, nor investigates the atomization and breakup mechanisms with simulation results.

The third method is the Eulerian interface tracking and particle trajectory tracking coupled method such as the volume of fluid (VOF)-DPM coupled method. By describing the primary atomization of the aeroengine fuel with the VOF interface tracking, and describing the droplet motions from the fuel breakup with the DPM particle trajectory tracking, the method fully combines the advantages of the interface tracking and the trajectory tracking, and can describe the process of the fuel from the primary atomization, secondary atomization, evaporation to the combustion. With the full combination of the interface tracking and the trajectory tracking, the method yields a higher calculation efficiency than the complete interface tracking. However, for real aeroengines, the number of droplets formed by the primary atomization of the fuels in the combustion chambers is still huge, and the descriptions on the small droplets with the trajectory tracking still consume lots of resources; and moreover, there are complicated interactions between the droplets such as collision-induced bounce, collision-induced coalescence and collision-induced breakup, and the fine-grained tracking is still time-consuming. In addition, the particle trajectory tracking is not accurate enough in calculation because it applies the collision probability model to the collisions between the droplets and cannot obtain details on the collisions between the droplets. Therefore, the development of a simulation technology with the faster speed, higher efficiency and higher calculation accuracy is of great significance to evaluate the atomization performance of the aeroengine fuel nozzles.

### SUMMARY

In view of the above problems, an objective of the present disclosure is to provide a performance prediction method and system for a whole atomization process of an aeroengine fuel.

To implement the above objective, the present disclosure provides the following solutions:

A performance prediction method for a whole atomization process of an aeroengine fuel includes:

establishing a three-dimensional (3D) geometric model for an aeroengine fuel atomizing nozzle and a spray flow field, the 3D geometric model being a mesh model;

establishing a physical fuel-gas-droplet multiphase flow model based on the 3D geometric model, the physical fuel-gas-droplet multiphase flow model including a physical fuel-gas two-phase flow model, a VOF functional model for tracking a gas-liquid two-phase interface as well as surface tension and viscous force constitutive models for the fuel;

obtaining a central velocity field and a fluid volume fraction distribution of meshes with a finite volume method (FVM) based on the physical fuel-gas two-phase flow model, the VOF functional model for tracking the gas-liquid two-phase interface as well as the surface tension and viscous force constitutive models for the fuel;

defining a gas and a liquid according to the central velocity field and the fluid volume fraction distribution;

performing mesh refinement on the gas-liquid two-phase interface with an orthogonal adaptive Cartesian mesh method;

transforming droplets less than a specified size in the atomization process into Lagrangian particle points; and

performing calculation on different volume fractions for the Lagrangian particles included in the meshes to obtain flow field data and droplet data on different time nodes.

Optionally, after the establishing a physical fuel-gas-droplet multiphase flow model, the performance prediction method may further include: selecting and determining physical parameters of each of the gas and the fuel in the atomization process.

Optionally, the establishing a physical fuel-gas-droplet multiphase flow model may specifically include:

establishing the physical fuel-gas two-phase flow model;

establishing the surface tension and viscous force constitutive models for the fuel;

establishing the VOF functional model for tracking the gas-liquid two-phase interface;

establishing a discrete dynamic model for droplets; and

establishing a pseudo-fluid model for the droplets.

Optionally, the performing calculation on different volume fractions for the Lagrangian particles included in the meshes to obtain flow field data and droplet data on different time nodes may specifically include:

discretizing the discrete dynamic model for the droplets with a discrete element method (DEM) when a volume fraction for a Lagrangian particle in each of the meshes is less than or equal to 0.02; and

discretizing the pseudo-fluid model for the droplets with a smoothed discrete particle hydrodynamics (SDPH) when the volume fraction for the Lagrangian particle in each of the meshes is greater than 0.02.

Preferably, the performance prediction method may further include:

performing the calculation with a secondary breakup model for the droplets, namely a Taylor analogy breakup (TAB) model, when a shear breakup occurs in the droplets; and

performing the calculation with an O′Rourke model when coalescence, bounce and breakup occur due to a mutual collision between the droplets.

Preferably, the performance prediction method may further include:

performing, for an interaction problem between a DEM particle and an SDPH particle, the calculation with an interaction method between DEM particles.

The present disclosure further provides a performance prediction system for a whole atomization process of an aeroengine fuel, including:

a 3D geometric model establishment module, configured to establish a 3D geometric model for an aeroengine fuel atomizing nozzle and a spray flow field, the 3D geometric model being a mesh model;

a physical multiphase flow model establishment module, configured to establish a physical fuel-gas-droplet multiphase flow model based on the 3D geometric model, the physical fuel-gas-droplet multiphase flow model including a physical fuel-gas two-phase flow model, a VOF functional model for tracking a gas-liquid two-phase interface as well as surface tension and viscous force constitutive models for the fuel;

a central velocity field and fluid volume fraction distribution determination module, configured to obtain a central velocity field and a fluid volume fraction distribution of meshes with an FVM based on the physical fuel-gas two-phase flow model, the VOF functional model for tracking the gas-liquid two-phase interface as well as the surface tension and viscous force constitutive models for the fuel;

a definition module, configured to define a gas and a liquid according to the central velocity field and the fluid volume fraction distribution;

a mesh refinement module, configured to perform mesh refinement on the gas-liquid two-phase interface with an orthogonal adaptive Cartesian mesh method;

a transformation module, configured to transform droplets less than a specified size in the atomization process into Lagrangian particle points; and

a calculation module, configured to perform calculation on different volume fractions for the Lagrangian particles included in the meshes to obtain flow field data and droplet data on different time nodes.

Based on specific embodiments provided in the present disclosure, the present disclosure discloses the following technical effects:

The present disclosure introduces the DEM to transform droplets less than a certain size into the Lagrangian particles, performs numerical calculation with the DEM, and describes the interaction between the droplets with a soft sphere model, thereby overcoming the low accuracy and poor reliability of the conventional particle trajectory model due to the fact that the collision result for collisions between the particles is directly obtained with the collision probability method. On the other hand, the present disclosure introduces a novel meshless particle simulation technology to describe the droplet group. Different from the conventional particle trajectory tracking method based on discrete particle dynamics, the novel particle simulation technology is based on the continuum mechanics, and is implemented by taking a large number of droplets as the pseudo-fluid and discretizing the droplets with the Lagrangian particle method, and each particle characterizes the droplet group having a certain particle size; and in this case, the large number of droplets in the actual combustion chamber can be characterized with a few particles, which not only tracks the motion trajectories of the droplets, but also obtains the macroscopic features of the droplets; and thirdly, on the basis of the above two methods, the present disclosure combines the interface tracking method for the primary atomization, to implement the performance prediction for the whole atomization process of the aeroengine fuel. The present disclosure has the advantages of less calculation burden, higher stability, adjustable liquid properties, trackable droplet trajectories, and so on, with good practicability and expansibility.

### BRIEF DESCRIPTION OF THE DRAWINGS

To describe the technical solutions in embodiments of the present disclosure or in the prior art more clearly, the accompanying drawings required in the embodiments will be briefly described below. Apparently, the accompanying drawings in the following description show merely some embodiments of the present disclosure, and other drawings can be derived from these accompanying drawings by those of ordinary skill in the art without creative efforts.

FIG. 1 is a flow chart of a performance prediction method for a whole atomization process of an aeroengine fuel according to an embodiment of the present disclosure;

FIG. 2 is a schematic view of a 3D geometric model for an aeroengine fuel atomizing nozzle and a spray flow field according to an embodiment of the present disclosure;

FIG. 3 is a schematic view of transforming a droplet into a Lagrangian particle point according to an embodiment of the present disclosure;

FIG. 4 is a schematic view of transformation into corresponding algorithms according to an embodiment of the present disclosure;

FIG. 5 is a schematic view of an interaction between a DPH particle and a DEM particle according to an embodiment of the present disclosure;

FIG. 6 illustrates a tendency of a phase interface during breakup and atomization of coaxially rotating liquid films according to an embodiment of the present disclosure (T=1, 3, 9, 12, 15); and

FIG. 7 illustrates an overlap of a circumferential section on a phase interface according to an embodiment of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by a person of ordinary skill in the art on the basis of the embodiments of the present disclosure without creative efforts shall fall within the protection scope of the present disclosure.

To make the above objectives, features, and advantages of the present disclosure clearer and more comprehensible, the present disclosure will be further described in detail below with reference to the accompanying drawings and the specific implementation.

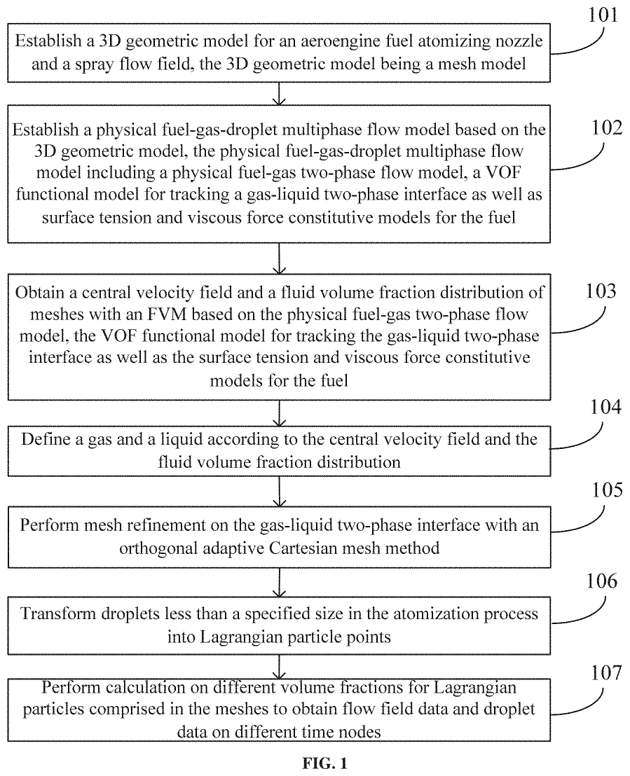

As shown in FIG. 1, the present disclosure provides a performance prediction method for a whole atomization process of an aeroengine fuel, including the following steps:

Step 101: Establish a 3D geometric model for an aeroengine fuel atomizing nozzle and a spray flow field, the 3D geometric model being a mesh model.

Step 102: Establish a physical fuel-gas-droplet multiphase flow model based on the 3D geometric model, the physical fuel-gas-droplet multiphase flow model including a physical fuel-gas two-phase flow model, a VOF functional model for tracking a gas-liquid two-phase interface as well as surface tension and viscous force constitutive models for the fuel.

Step 103: Obtain a central velocity field and a fluid volume fraction distribution of meshes with an FVM based on the physical fuel-gas two-phase flow model, the VOF functional model for tracking the gas-liquid two-phase interface as well as the surface tension and viscous force constitutive models for the fuel.

Step 104: Define a gas and a liquid according to the central velocity field and the fluid volume fraction distribution.

Step 105: Perform mesh refinement on the gas-liquid two-phase interface with an orthogonal adaptive Cartesian mesh method.

Step 106: Transform droplets less than a specified size in the atomization process into Lagrangian particle points.

Step 107: Perform calculation on different volume fractions for the Lagrangian particles included in the meshes to obtain flow field data and droplet data on different time nodes. Specifically, the discrete dynamic model for the droplets is discretized with a DEM when a volume fraction for a Lagrangian particle in each of the meshes is less than or equal to 0.02; and the pseudo-fluid model for the droplets is discretized with an SDPH when the volume fraction for the Lagrangian particle in each of the meshes is greater than 0.02.

Step 101 specifically includes:

The 3D geometric model for the nozzle and the spray flow field is established with commercial software Unigraphics (UG) and then imported to meshing software ANSYS-ICEM for regular meshing. FIG. 2 illustrates a geometric model for a structure of a dual-orifice centrifugal atomizing nozzle of an aeroengine, including the left inlet and outlets at other five boundaries, where the dark ring represents the fuel inlet nozzle.

Step 102 specifically includes:

The physical fuel-gas-droplet multiphase flow model is established as follows: The physical fuel-gas two-phase flow model is established; the surface tension and viscous force constitutive models for the fuel are established; the VOF functional model for tracking the gas-liquid two-phase interface is established; a discrete dynamic model for the droplets is established; and a pseudo-fluid model for a large number of droplets is established.

For primary atomization of the fuel, an unsteady incompressible Navier-Stokes equation is used to establish the physical fuel-gas two-phase flow model; and both the surface tension model and the viscous force model are used as source terms and added to the Navier-Stokes equation. The equation is expressed as follows:

$$ρ ( \frac{\partial u}{\partial t} + u \cdot ∇ u ) = - ∇ p + ∇ \cdot ( 2 μ D ) + ρ g + σ κ {δ}_{s} n + {f}^{bp} \qquad ( 1 )$$

$$\frac{\partial ρ}{\partial t} + ∇ \cdot ( ρ \cdot u ) = 0 \qquad ( 2 )$$

$$∇ \cdot u = 0 \qquad ( 3 )$$

Σ is a density of the fuel, u is a velocity of the fuel, t is time, P is an internal pressure of the fuel, μ is a dynamic viscosity of the fuel, σ is a coefficient of surface tension of the fuel liquid, Dᵢⱼ=(∂ᵢuⱼ+∂ⱼuᵢ)/2 is a deformation tenser, κ is a curvature of the fuel-gas two-phase interface, n is a unit normal vector of the fuel-gas two-phase interface, δ, is an absolute value of the normal vector on the two-phase interface, g is a gravitational acceleration, and f^{bp} is an acting force of the wall to the gas-liquid two-phase fluid.

The discrete dynamic model for the droplets is established with the following equations:

$$\frac{d {v}^{α}}{dt} = \frac{{F}_{drag}^{α} + {F}_{g}^{α} + {F}_{col}^{α}}{m} \qquad ( 4 )$$

$${F}_{drag}^{α} = \frac{π {r}_{p}^{2}}{2} {C}_{D} ρ \vert v - {v}_{p} \vert ( {v}^{α} - {v}_{p}^{α} ) \qquad ( 5 )$$

$${F}_{g} = \frac{1}{6} π {d}_{p}^{2} {ρ}_{p} g \qquad ( 6 )$$

F_{drag} is a drag of the gas stressed on the droplets, F_{g} is a self gravity of the droplets, F_{col} is a collision acting force between the droplets, m is a mass of the droplets, α represents three directions x, y, z in the rectangular coordinate system, rₚ is a radius of the droplets, C_{D} is a drag coefficient, v is a velocity vector of the gas flow field, vₚ is a velocity vector of the droplets, and ρₚ is a density of the droplets.

To track the gas-liquid two-phase interface, the VOF functional method is used to establish a physical interface tracking model. In a case where only the gas and liquid phases exist, the physical equation of the material is as follows:

ρ=φ₁ρ₁+(1−φ₁)ρ₂ (7)

μ=φ₁μ₁+(1−φ₁)μ₂ (8)

The transport equation for the volume fraction is given by:

$$\frac{\partial }{\partial t} {φ}_{q} {ρ}_{q} + ∇ \cdot ( {φ}_{q} {ρ}_{q} {u}_{q} ) = 0 \qquad ( 9 )$$

The pseudo-fluid model for the large number of droplets is given by:

$$\frac{d {θ}_{p}}{dt} = \frac{2}{3} [ \frac{{σ}^{α β}}{ρ} \frac{\partial {v}^{α}}{\partial {x}^{β}} + \frac{\partial }{\partial {x}^{β}} ( {k}_{p} \frac{\partial {θ}_{p}}{\partial {x}^{β}} ) - {N}_{c} {θ}_{p} ] \qquad ( 10 )$$

The equation describes a conservation relation for pseudo-temperatures of the droplets, the pseudo-temperature is θ= [symbol] C² [symbol] /3, C being a fluctuating velocity of the droplets,

$${C}^{α} = {v}^{α} - {\overline{v}}^{α} \frac{{σ}^{α β}}{ρ} \frac{\partial {v}^{α}}{\partial {x}^{β}}$$

is energy generated by a stress between the particles,

$$k \frac{\partial θ}{\partial {x}^{β}}$$

is an energy dissipation term, k is an energy dissipation coefficient, and N_{c}θ is an energy dissipation term generated by a collision between the particles. The specific parametric equation is as follows:

$${k}_{p} = 2 {φ}_{p}^{2} {ρ}_{p} {d}_{p} {g}_{0} ( 1 + {e}_{pp} ) \sqrt{\frac{{θ}_{p}}{π}} + \frac{2 \frac{75 \sqrt{π}}{384} {ρ}_{p} {d}_{p} \sqrt{{θ}_{p}}}{{g}_{0} ( 1 + {e}_{pp} )} {( 1 + \frac{6}{5} {φ}_{p} {g}_{0} ( 1 + e ) )}^{2} \qquad ( 11 )$$

$${N}_{c} {θ}_{p} = 3 ( 1 - {e}^{2} ) {φ}_{p}^{2} {ρ}_{p} {g}_{0} {θ}_{p} [ \frac{4}{{d}_{p}} \sqrt{\frac{{θ}_{p}}{π}} - ∇ \cdot {v}_{p} ] \qquad ( 12 )$$

φₚ is a volume fraction of the droplets. According to the kinetic theory of granular flow (KTGF), the phase pressure pₚ and viscous stress τₚ of the droplets are related to the maximum value of the velocity fluctuation of the droplets, and the velocity fluctuation of the droplets is described by the pseudo-temperatures of the droplets. The pseudo-temperature conservation equation of the droplets is as shown by Equation (10).

$$p = {φ}_{p} {ρ}_{p} [ 1 + 2 ( 1 + e ) {φ}_{p} {g}_{0} ] {θ}_{p} \qquad ( 13 )$$

$${τ}^{αβ} = \frac{4 {φ}_{p}^{2} {ρ}_{g} {d}_{p} {g}_{0} ( 1 + {e}_{pp} )}{3} \sqrt{\frac{{θ}_{p}}{π}} \frac{\partial {v}_{p}^{α}}{\partial {x}^{α}} {δ}^{αβ} + \qquad ( 14 )$$

$$2 [ \frac{4 {φ}_{p}^{2} {ρ}_{p} {d}_{p} {g}_{0} ( 1 + {e}_{pp} )}{5} \sqrt{\frac{{θ}_{p}}{π}} + \frac{2 \frac{5 \sqrt{π}}{96} {ρ}_{p} {d}_{p} \sqrt{{θ}_{p}}}{{g}_{0} ( 1 + {e}_{pp} )} {( 1 + \frac{4}{5} {φ}_{p} {g}_{0} ( 1 + {e}_{pp} ) )}^{2} ]$$

In the equations, dₚ is a diameter of the particle; eₚₚ is a collision coefficient of restitution (COR) between the particles; ζₚ is an effective bulk viscosity of the particle phase generated by particle collisions, which is an intermediate variable; and g₀ is a radial COR of the particle:

$${g}_{0} = {[ 1 - {( \frac{{φ}_{p}}{{φ}_{s , max}} )}^{\frac{1}{3}} ]}^{- 1} \qquad ( 15 )$$

φ_{s,max} is the maximum volume fraction that the particle medium can reach under compressible conditions.

After the model is established, physical parameters of each of the gas and the fuel in the atomization process are selected. According to the physical gas-liquid-droplet multiphase flow model established in Step 102, physical parameters involved therein are selected, specifically, the gas has the density of ρ_{g}=1.228 kg/m³ and the viscosity of η_{g}=1.8×10⁻⁵ Pa·s, the aeroengine fuel liquid has the density of ρ₁=780 kg/m³ and the viscosity of ηₜ=3.0×10⁻³ Pa·s, and the surface tension on the gas-liquid interface is 0.0758 N/m.

Step 103 specifically includes:

Time discretization is performed on Equations (1) and (9) to obtain:

$$\frac{{ρ}_{n + \frac{1}{2}}}{Δ t} {u}_{*} - ∇ \cdot [ {μ}_{n + \frac{1}{2}} {D}_{*} ] = ∇ \cdot [ {μ}_{n + \frac{1}{2}} {D}_{n} ] + {( σ {κδ}_{s} n )}_{n + \frac{1}{2}} + {ρ}_{n + \frac{1}{2}} [ \frac{{u}_{n}}{Δ t} - {u}_{n + \frac{1}{2}} \cdot ∇ {u}_{n + \frac{1}{2}} ] \qquad ( 16 )$$

$$\frac{{c}_{n + \frac{1}{2}} - {c}_{n - \frac{1}{2}}}{Δ t} + ∇ \cdot ( {c}_{n} {u}_{n} ) = 0 \qquad ( 17 )$$

Meanwhile, Equations. (1) and (2) are deduced to obtain the following Poisson's equation:

$$∇ \cdot [ \frac{Δ t}{{ρ}_{n + \frac{1}{2}}} ∇ {p}_{n + \frac{1}{2}} ] = ∇ \cdot {u}_{*} \qquad ( 18 )$$

In addition,

$${u}_{n + 1} = {u}_{*} - \frac{Δ t}{{ρ}_{n + \frac{1}{2}}} ∇ {p}_{n + \frac{1}{2}} \qquad ( 19 )$$

In the above equation, u* is an intermediate velocity term that is approximately calculated according to the following equation:

$$∇ \cdot {u}_{*} = \frac{1}{Δ} {\sum }_{f} {u}_{*}^{f} \cdot {n}^{f} \qquad ( 20 )$$

n^{f} is a unit normal vector of the face, and Δ is a length of the governing body.

After Equation (18) is solved, pressure correction is performed on the intermediate velocity term of the face center:

$${u}_{n + 1}^{f} = {u}_{*}^{f} - \frac{Δ t}{{ρ}_{n + \frac{1}{2}}^{f}} {∇}^{f} {p}_{n + \frac{1}{2}} \qquad ( 21 )$$

In the equation, ∇^{f} is a gradient operator in the face center.

By applying the pressure correction to the volume center, a velocity field having n+1 steps in the volume center can be obtained

$${u}_{n + 1}^{c} = {u}_{*}^{c} - {\vert \frac{Δ t}{{ρ}_{n + \frac{1}{2}}^{f}} {∇}^{f} {p}_{n + \frac{1}{2}} \vert}^{c} \qquad ( 22 )$$

In the equation, the operator ∥^{c} represents an average calculating operation on all faces of the governing body.

The above governing equation is solved as follows:

1) The volume fraction, velocity and boundary condition of the VOF function are initially set.

2) Equation (17) is solved according to the volume fraction Cₙ and the velocity vector uₙ at the present moment to obtain

$${C}_{n + \frac{1}{2}} .$$

3)

$${ρ}_{n + \frac{1}{2}} and {μ}_{n + \frac{1}{2}}$$

are calculated with

$${C}_{n + \frac{1}{2}}$$

### and Equations (7) and (8).

4) The transport term

$${u}_{n + \frac{1}{2}} \cdot ∇ {u}_{n + \frac{1}{2}}$$

is calculated with a second order upwind (SOU) scheme according to

$${ρ}_{n + \frac{1}{2}}$$

and uₙ.

5) The viscosity term is directly discretized with a Crank-Nicholson method and a spatial central-difference scheme (CDS) according to

$${μ}_{n + \frac{1}{2}}$$

and uₙ.

6) The surface tension term

$${( σ κ {δ}_{s} n )}_{n + \frac{1}{2}}$$

is calculated according to

$${C}_{n + \frac{1}{2}}$$

and the surface tension model.

7) Equation (16) is solved on the basis of Steps (1)-(6) to obtain u*.

8) The Poisson's equation is calculated on the basis of u* to obtain

$${p}_{n + \frac{1}{2}} .$$

9) uₙ₊₁ is calculated according to

$${u}_{*} , {p}_{n + \frac{1}{2}} and {ρ}_{n + \frac{1}{2}}$$

as well as Equation (19).

10) Steps (1)-(9) are circulated to obtain the result at the next moment.

Step 105 specifically includes:

In order to accurately capture evolutions of the interface, the mesh refinement is performed on the interface with the orthogonal adaptive Cartesian mesh method, specifically:

1) Adaptive mesh criteria are set: volume fraction 0<C<1.

2) All leaf mesh cells meeting the adaptive mesh criteria are encrypted at a set highest level, neighboring meshes are also encrypted with constraint conditions, and this process is repeated until the adaptive criteria and the constraint conditions are all met.

3) Mother mesh cells for the all leaf mesh cells are processed, and mother mesh cells meeting the encryption criteria and the constraint conditions are encrypted, and mesh cells not meeting the encryption criteria are sparsified.

Variables of new meshes obtained after the mesh encryption or sparsification are initialized. For new meshes generated after the encryption, variable values of the new meshes are calculated with a simple linear interpolation algorithm according to the variable value and the gradient value of the mother mesh. For new meshes generated after the sparsification, volume fractions of sub-meshes before the sparsification are added and averaged to ensure the accuracy of the variables.

Step 106 specifically includes:

During the atomization of the fuel, a large number of small droplets are generated. Droplets of which the diameters are close to or less than 4-6 mesh scales and the shapes are close to spheres are transformed into the particles. The transformation criteria are described as:

$${V}_{d} \leq {V}_{cut} \qquad ( 23 )$$

$$e = {max}_{{Γ}_{d}} \frac{‖ x - {x}_{d} ‖}{max ( Δ {x}_{g} , {R}_{d} )} \leq {e}_{cut} \qquad ( 24 )$$

In the equations, V_{d} is a volume of the liquid structure, V_{cut} cut is a volume transformation standard, and e is an eccentricity of the liquid structure and represents a ratio of the distance from any point on the interface to the center of mass to the radius R_{d} of the droplets equivalent to the mesh scale Δx_{g}. The shape criterion eₒᵤₜ is 1.5.

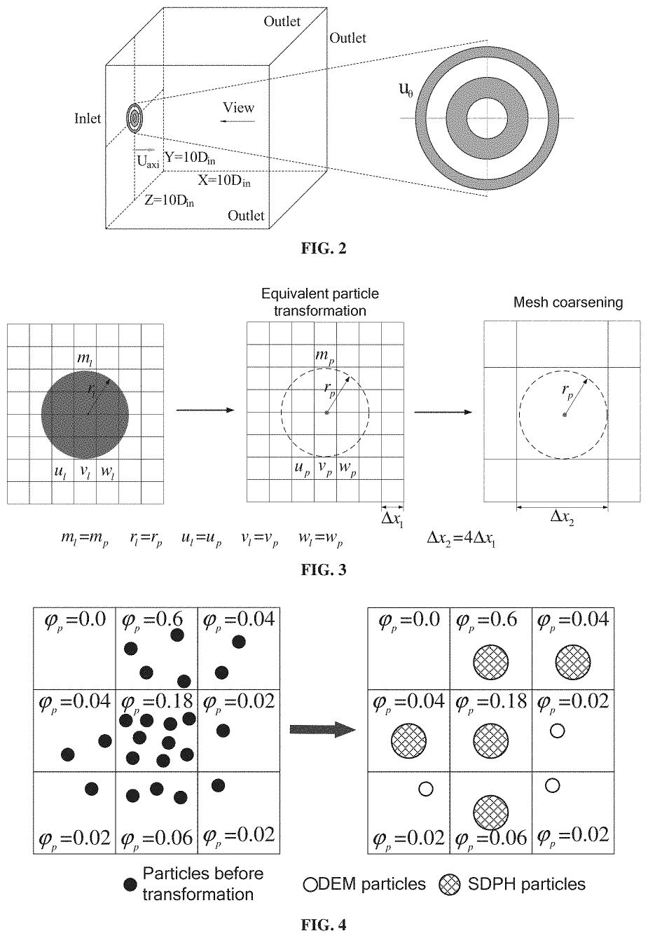

FIG. 3 illustrates the schematic view of the transformation process. Without changing sizes, masses and velocities, the particles before and after the transformation are different, specifically: the droplets before the transformation are actual droplets including continuous interfaces and the interfaces are located on the meshes; and the transformed particles do not have the real surfaces, the interfaces are not tracked and positioned, and the sizes of the particles are determined by the radii of the particles. Upon the transformation of the particles, the meshes are coarsened, specifically, original 4×4 (two-dimensional (2D)) meshes are transformed into a coarse mesh, as shown in FIG. 3, mᵢ=mₚ, rₗ=rₚ, uₗ=uₚ, vₗ=vₚ, wₗ=wₚ, Δx₂=Δx₁.

Step 107 specifically includes:

On the basis of Step 106, volume fractions of droplets in each coarse mesh are calculated according to the following equation:

$${φ}_{p} = \frac{\sum {V}_{p}}{{V}_{m}} \qquad ( 25 )$$

ΣVₚ is a sum for volumes of all droplets in the mesh, and Vₘ is a volume of the mesh.

1. For droplets having the volume fraction of less than or equal to 0.02 in the mesh, Equation (4) is discretized with the DEM, and the calculation equation is as follows:

$${m}_{i} \frac{d {v}_{i}^{α}}{dt} = {\sum }_{j = 1}^{k} ( {F}_{c , ij}^{α} + {F}_{d , ij}^{α} ) + {m}_{i} g + {F}_{drag}^{α} \qquad ( 33 )$$

In the equation, mᵢ is a mass of the particle i, vᵢ^{α} is a velocity of the particle i in the α direction, t is time, mᵢg is a gravitational force stressed on each particle, F_{c,ij}^{α} and F_{d,ij}^{α} are respectively a contact force and a viscous contact damping force of the particles i and j, and kᵢ is a total number of particles in contact with each particle.

The contact force F_{c,ij}^{α} between the particles i and j is decomposed into a normal contact force and a tangential contact force, namely:

F_{c,ij}^{α}=F_{cn,ij}^{α}+F_{ct,ij}^{α} (34)

The normal contact force is calculated with a Hertz model:

$${F}_{cn , ij}^{α} = - \frac{4}{3} {E}^{*} \sqrt{{R}^{*}} {δ}_{n}^{3 / 2} {n}^{α} \qquad ( 35 )$$

In the equation

$${E}^{*} = \frac{E}{2 ( 1 - {v}^{2} )} , {R}^{*} = \frac{1}{{R}_{i}} + \frac{1}{{R}_{j}} \qquad ( 36 )$$

δₙ is a penetration depth when the particles i and j are in contact:

δₙ=Rᵢ+Rⱼ−|Rⱼ−Rᵢ| (37)

The tangential contact force is calculated with a Coulomb criterion:

$$\vert {F}_{ct , ij} \vert = \{ \begin{matrix}\vert {F}_{ct , ij} \vert , & \vert {F}_{ct , ij} \vert < {μ}_{s} \vert {F}_{cn , ij} \vert \\ {μ}_{s} \vert {F}_{cn , ij} \vert , & \vert {F}_{ct , ij} \vert \geq {μ}_{s} \vert {F}_{cn , ij} \vert\end{matrix} \qquad ( 38 )$$

In the equation, μₛ is a coefficient of static friction, and the direction of tangential friction is opposite to the trend of relative slipping.

The viscous contact damping force F_{d,ij}^{α} is also decomposed into normal and tangential components, namely:

F_{d,ij}^{α}=F_{dn,ij}^{α}+F_{dt,ij}^{α} (39)

The normal viscous contact damping force F_{dn,ij}^{α} is calculated as follows:

F_{dn,ij}^{α}=−cₙ(vᵢⱼ^{α}·n^{α})n^{α} (40)

In the equation, cₙ is a normal viscous contact damping coefficient.

The tangential contact damping forceis calculated as follows:

F_{dt,ij}^{α}=cᵢ(vᵢⱼ×n)×n (41)

In the equation, cₜ is a tangential viscous contact damping coefficient.

2. For droplets having the volume fraction of greater than 0.02 in the mesh, the mesh cell is transformed into one SDPH particle, and Equations (1), (2) and (10) are discretized with the SDPH method. The calculation equations are as follows:

$$\frac{d {ρ}_{i}}{dt} = {\sum }_{j = 1}^{N} {m}_{j} ( {v}_{1}^{α} - {v}_{j}^{α} ) \cdot \frac{\partial {W}_{ij}}{\partial {x}^{α}} \qquad ( 42 )$$

$$\frac{d {v}_{i}^{α}}{dt} = {\sum }_{j = 1}^{N} {m}_{j} ( \frac{{σ}_{i}^{αβ}}{{ρ}_{i}^{2}} + \frac{{σ}_{j}^{αβ}}{{ρ}_{j}^{2}} ) \frac{\partial {W}_{ij}}{\partial {x}^{β}} + {f}^{α} \qquad ( 43 )$$

$$\frac{d θ}{dt} = \frac{2}{3} ( \frac{1}{2} {\sum }_{j = 1}^{N} {m}_{j} {v}_{j i} ( \frac{{σ}_{i}^{αβ}}{{ρ}_{i}^{2}} + \frac{{σ}_{j}^{αβ}}{{ρ}_{j}^{2}} - {\prod }_{ij} ) \frac{\partial {W}_{ij}}{\partial {x}^{β}} + {\sum }_{j = 1}^{N} {m}_{j} ( \frac{{{k}_{p} ( ∇ θ )}_{i}^{αβ}}{{ρ}_{i}^{2}} + \frac{{{k}_{p} ( ∇ θ )}_{j}^{αβ}}{{ρ}_{j}^{2}} ) \frac{\partial {W}_{ij}}{\partial {x}^{β}} - {N}_{c} {θ}_{i} ) \qquad ( 44 )$$

In the equations, i, j are the particle i and the particle j respectively, Wᵢⱼ is a value of a kernel function between the particle i and the particle j, W is the kernel function, and h is a smoothing length.

In SDPH, the mass of the SDPH particle is the same as the total mass of the represented droplet group, the density is the effective density of the droplet group, the velocity is the mean velocity of the droplet group, and the pseudo-temperature and pressure are the mean pseudo-temperature and mean pressure of the represented droplet group. Meanwhile, the SDPH particle carries the mean particle size, variance and number of single particles that characterize the particle size distribution of the droplet group.

The discretization equation in the SDPH for the pseudo-temperature gradient ∇θ is:

$${( ∇ θ )}_{i}^{α} = {m}_{i} {\sum }_{j = 1}^{N} \frac{{θ}_{j} - {θ}_{i}}{{ρ}_{ij}} \frac{\partial {W}_{ij}}{\partial {x}^{α}} \qquad ( 45 )$$

The equations for the pressure and shear force of the particle during enclosure of the above equations are Equations (13) to (15).

As shown in FIG. 4, solid particles are particles before the transformation, small hollow particles are DEM particles, and large meshed particles are SDPH particles. For the mesh where the volume fraction for the droplets is less than 0.02, the droplets are directly transformed into the DEM particles, and the DEM particles are the same as the transformed particles in FIG. 3 in terms of the size, density, mass, velocity and the like. For the mesh where the volume fraction for the droplets is greater than 0.02, the mesh is transformed into one SDPH particle; and the density of the SDPH particle is a product of the actual density of the droplets and the volume fraction of the droplets in the mesh, the mass of the SDPH particle is the total mass of the droplets in the mesh, the number of droplets carried by the SDPH particle is the total number of droplets in the mesh, the position of the SDPH particle is a center point of the mesh, and the velocity of the SDPH particle is a velocity interpolation of all droplets in the mesh at the center point of the mesh.

3. Methods for further handling secondary breakup of the droplets and mutual collusions between the droplets

For the shear breakup due to a blowing effect of the gas in the subsequent motions of the droplets, the secondary breakup model (TAB model) for the droplets are used for calculation to obtain further breakup details of the droplets; and for the coalescence, bounce and breakup due to mutual collisions between the droplets, the O′Rourke is used for calculation to obtain the result after the collision of the droplets.

4. For interaction between the SDPH particle and the DEM particle

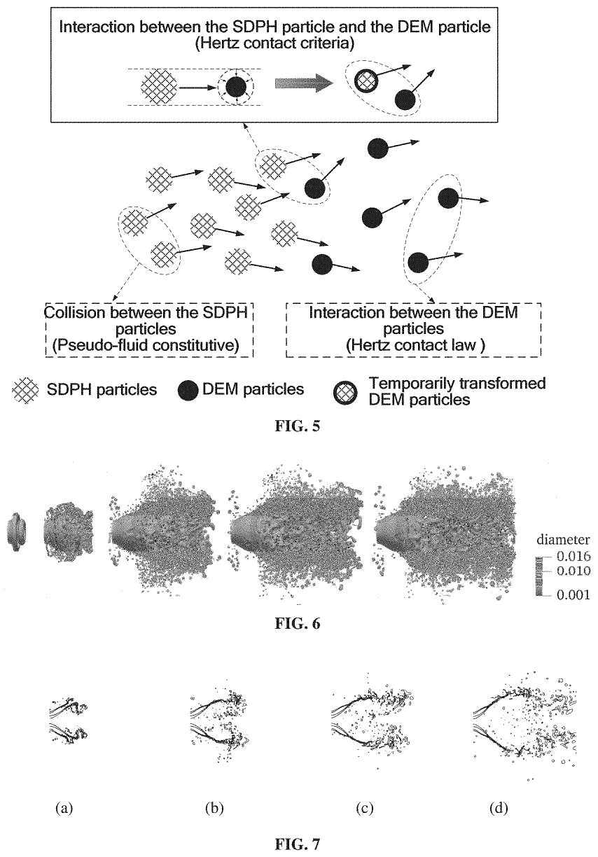

For the interaction between the SDPH particle and the DEM particle after the transformation, the following policy is used for calculation, with the schematic view as shown in FIG. 5. Generally, the interaction between the DEM particle and the SDPH particle is calculated with an interaction method between DEM particles. According to the method of transforming SDPH particles into DEM particles, the SDPH particles are transformed into DEM particles invisibly, and then the interacting force between SDPH and DEM particles (equivalent to two DEM particles) is calculated, including a contact force F_{c,ij}=F_{cn,ij}+F_{ct,ij} and a normal contact damping force F_{d,ij}=F_{dn,ij}+F_{dt,ij}. The forces acting between SDPH and DEM particles are equal in magnitude and opposite in direction, and are added to the calculation of the respective equations as the source terms of the momentum equation: SDPH momentum equation considering the effect of DEM particles on SDPH particles

$$\frac{d {v}_{i , SDPH}^{α}}{dt} = {\sum }_{j = 1}^{N} {m}_{j} ( \frac{{σ}_{i}^{αβ}}{{ρ}_{i}^{2}} + \frac{{σ}_{j}^{αβ}}{{ρ}_{j}^{2}} ) \frac{\partial {W}_{ij}}{\partial {x}^{β}} + {g}^{α} + {F}_{DEM}^{α} \qquad ( 46 )$$

DEM momentum equation considering the effect of SDPH particles on DEM particles

$${m}_{i} \frac{d {v}_{i , DEM}}{dt} = {\sum }_{j = 1}^{{k}_{i}} ( {F}_{c , ij} + {F}_{d , ij} ) + {m}_{i} g + {F}_{SDPH} \qquad ( 47 )$$

F_{DEM}^{α} is a component of the force of DEM particles acting on SDPH particles in a direction, and F_{SDPH} is a vector of the force of DEM particles acting on SDPH particles.

Boundary conditions and time steps for the inlets and outlets are determined.

The present disclosure initially calculates the fuel injection process with the FVM. Therefore, boundaries for the inlets, outlets and walls are introduced into the FVM. Concerning the fuel injection, it is assumed that the inlet is the velocity inlet boundary, the gas flows to the flow field along the normal line of the inlet, and the flowing outlet boundary condition is imposed at the outlet, namely the velocity gradient is zero, ∂uₓ/∂x=0. Along the boundaries of walls, the no-slip boundary condition u_{gx}=u_{gy}=u_{gz}=0 is imposed on the gas and liquid phases. The time step is 10⁻⁶ s.

Time integration is performed on field variables dρ, dv, dθₚ and displacements dxᵢ of the particles in Step 107 to obtain field variables at different time. The time integration scheme is as follows:

The explicit time integration scheme is used to obtain solutions of the particles. The leapfrog integration exhibits second-order time accuracy, low memory capacity, and high calculation efficiency.

φᵢ(t+δt/2)=φᵢ(t−δt/2)+\dot{φ}ᵢ(t)δt (48)

xᵢ(t+=δt)=xᵢ(t)+vᵢ(t+δt/2)δt (49)

In the equations, φ represents a combination of the density ρ, velocity v and pseudo-temperature θₚ of the substance, and xᵢ is the position coordinate at the particle i.

Implementation with Computer Programming

The models and algorithms established in Steps 103-107 are implemented by computer programming The C++ programming language is used, and the compiling environment is the Linux system. In the hardware environment, the processor is Intel® Core™ i7-10510U CPU @ 1.80 GHz 2.30 GHz, with the memory of 16 GB, 16 cores, and the hard drive capacity of 500 G.

Computer Simulated Calculation

Compilation is performed on the basis of the implementation with the computer programming The multi-core parallel method is used to calculate the whole process from the liquid films and liquid threads to the droplets, secondary breakup of the droplets, collisions between the droplets and so on after the fuel and gas enters the spatial flow field through the nozzle, to obtain flow field data and droplet data on different time nodes, including ρ, v, θₚ, xᵢ and dₚ.

Result Post-Processing

According to data output methods provided by program control information, commercial software Tecplot is used to output all field variables to generate related animations. According to particle/node codes and variable type codes provided by the program control information, time course curves of related variables are generated. FIG. 6 illustrates morphological changes, spatial distributions and so on of liquid films, liquid threads and droplets processed by tecplot software during breakup of coaxially rotating liquid films.

FIG. 7 illustrates an overlap of circumferential sections of 0°−180°, 60°−240°, 120°−300° on the phase interface at dimensionless time of T=3,6,9,15, where T=3 in FIG. 7(a), T=6 in FIG. 7(b), T=9 in FIG. 7(c), and T=15 in FIG. 7(d). Before mutual collusions, internal and external rotating liquid films are smooth and extends downward, with the good axial symmetry. After the liquid films contact, there shows serious asymmetric disturbance on the fused surface due to the strong momentum exchange. A sealed air chamber is formed between the internal and external liquid films. As the time goes on, the liquid structure is extended and dispersed to a wider space, and the fused liquid films are broken within a short distance. It is indicated by the spatial distributions and unreeling motions of the downward liquid threads and droplets that a stable recirculation region is formed in the extended liquid films.

Result analysis and mechanism disclosure

By dynamically displaying the atomization process of the fuel, atomization results under influences of different parameters are analyzed to obtain atomization rules of the fuel and reveal evolutions of the gas-liquid two-phase interface as well as physical mechanisms of the droplets in secondary atomization; and upon this, the theoretical prediction model for the atomization of the fuel is established to design aeroengine fuel atomizers; and on the other hand, atomization features of different fuel atomizers, atomization features of different fuels, and atomization features under different environmental conditions can be directly predicted to provide data bases to optimize the fuel atomizers, research and develop novel replacement fuels and improve the working environments of the engine.

The present disclosure has the following advantages:

(1) The present disclosure breaks through the conventional situation that the interface tracking is only used to simulate the primary atomization and when the interface tracking is used for the secondary atomization, the huge calculation burden arising from mesh adaption cannot be effectively solved; and by introducing the particle simulation, the present disclosure unnecessarily simulates the secondary atomization with the interface tracking, can accurately calculate the secondary breakup of the droplets and the collision between the droplets in the secondary atomization, and greatly reduces the calculation burden.

(2) The present disclosure breaks through the conventional situation that the particle trajectory tracking is only used to simulate the secondary atomization but not the primary atomization on breakup of the liquid film and liquid thread, and the particle trajectory tracking starts the calculation after the droplets are formed upon the atomization and ignores the primary atomization. To sum up, details in the atomization process cannot be described with the particle trajectory tracking. However, the present disclosure fully combines the interface tracking process for the primary atomization, and directly starts the calculation when the fuel enters the atomizer, thus effectively capturing the motion of the fuel in the nozzle, the accumulation of the fuel at the nozzle outlet, formation and breakup of the liquid film, formation and breakup of the liquid thread, formation and motion of the droplet and so on, and overcoming the shortages of the particle trajectory tracking.

(3) The present disclosure further solves the shortages of the existing interface tracking and particle trajectory tracking coupled technology for simulation on whole atomization process of the fuel. The existing coupled method is implemented by applying the particle trajectory tracking to the secondary atomization, actually modeling all droplets in the primary atomization with the huge calculation burden, and applying the probability model to the collision between the droplets to directly obtain the collision result rather than the actual motions of the droplets in the collision. By introducing the DEM instead of the particle trajectory tracking, the present disclosure calculates the collision between the droplets with the soft sphere model to obtain deformation and motion details in the collision; and on the other hand, the present disclosure transforms the spatial volume fraction of the droplets with algorithms, and specifically transforms the droplet groups having the volume fraction of greater than 0.02 and reaching the pseudo-fluid regime into the SDPH method for simulation, characterizes a series of droplet groups having a certain particle size with one SDPH particle, and describes the interaction between the droplets with the pseudo-fluid model, thus greatly reducing the calculation burden and improving the calculation accuracy.

The present disclosure further provides a performance prediction system for a whole atomization process of an aeroengine fuel, including:

a 3D geometric model establishment module, configured to establish a 3D geometric model for an aeroengine fuel atomizing nozzle and a spray flow field, the 3D geometric model being a mesh model;

a physical multiphase flow model establishment module, configured to establish a physical fuel-gas-droplet multiphase flow model based on the 3D geometric model, the physical fuel-gas-droplet multiphase flow model including a physical fuel-gas two-phase flow model, a VOF functional model for tracking a gas-liquid two-phase interface as well as surface tension and viscous force constitutive models for the fuel;

a central velocity field and fluid volume fraction distribution determination module, configured to obtain a central velocity field and a fluid volume fraction distribution of meshes with an FVM based on the physical fuel-gas two-phase flow model, the VOF functional model for tracking the gas-liquid two-phase interface as well as the surface tension and viscous force constitutive models for the fuel;

a definition module, configured to define a gas and a liquid according to the central velocity field and the fluid volume fraction distribution;

a mesh refinement module, configured to perform mesh refinement on the gas-liquid two-phase interface with an orthogonal adaptive Cartesian mesh method;

a transformation module, configured to transform droplets less than a specified size in the atomization process into Lagrangian particle points; and

a calculation module, configured to perform calculation on different volume fractions for the Lagrangian particles included in the meshes to obtain flow field data and droplet data on different time nodes.

The embodiments are described herein in a progressive manner. Each embodiment focuses on the difference from another embodiment, and the same and similar parts between the embodiments may refer to each other. Since the system disclosed in the embodiments corresponds to the method disclosed in the embodiments, the description is relatively simple, and reference can be made to the method description.

Specific examples are used herein to explain the principles and embodiments of the disclosure. The foregoing description of the embodiments is merely intended to help understand the method of the present disclosure and its core ideas; besides, various modifications may be made by the person of ordinary skill in the art to specific embodiments and the scope of application in accordance with the ideas of the present disclosure. In conclusion, the content of this specification shall not be construed as a limitation to the present disclosure.

What is claimed is:

1. A performance prediction method for a whole atomization process of an aeroengine fuel, comprising:
establishing a three-dimensional (3D) geometric model for an aeroengine fuel atomizing nozzle and a spray flow field, the 3D geometric model being a mesh model;
establishing a physical fuel-gas-droplet multiphase flow model based on the 3D geometric model, the physical fuel-gas-droplet multiphase flow model comprising a physical fuel-gas two-phase flow model, a volume of fluid (VOF) functional model for tracking a gas-liquid two-phase interface as well as surface tension and viscous force constitutive models for the fuel;
obtaining a central velocity field and a fluid volume fraction distribution of meshes with a finite volume method (FVM) based on the physical fuel-gas two-phase flow model, the VOF functional model for tracking the gas-liquid two-phase interface as well as the surface tension and viscous force constitutive models for the fuel;
defining a gas and a liquid according to the central velocity field and the fluid volume fraction distribution;
performing mesh refinement on the gas-liquid two-phase interface with an orthogonal adaptive Cartesian mesh method;
transforming droplets less than a specified size in the atomization process into Lagrangian particle points; and
performing calculation on different volume fractions for the Lagrangian particles comprised in the meshes to obtain flow field data and droplet data on different time nodes.

2. The performance prediction method for a whole atomization process of an aeroengine fuel according to claim 1, after the establishing a physical fuel-gas-droplet multiphase flow model, further comprising: selecting and determining physical parameters of each of the gas and the fuel in the atomization process.

3. The performance prediction method for a whole atomization process of an aeroengine fuel according to claim 1, wherein the establishing a physical fuel-gas-droplet multiphase flow model specifically comprises:
establishing the physical fuel-gas two-phase flow model;
establishing the surface tension and viscous force constitutive models for the fuel;
establishing the VOF functional model for tracking the gas-liquid two-phase interface;
establishing a discrete dynamic model for droplets; and
establishing a pseudo-fluid model for the droplets.

4. The performance prediction method for a whole atomization process of an aeroengine fuel according to claim 3, wherein the performing calculation on different volume fractions for the Lagrangian particles comprised in the meshes to obtain flow field data and droplet data on different time nodes specifically comprises:
discretizing the discrete dynamic model for the droplets with a discrete element method (DEM) when a volume fraction for a Lagrangian particle in each of the meshes is less than or equal to 0.02; and
discretizing the pseudo-fluid model for the droplets with a smoothed discrete particle hydrodynamics (SDPH) when the volume fraction for the Lagrangian particle in each of the meshes is greater than 0.02.

5. The performance prediction method for a whole atomization process of an aeroengine fuel according to claim 3, further comprising:
performing the calculation with a secondary breakup model for the droplets, namely a Taylor analogy breakup (TAB) model, when a shear breakup occurs in the droplets; and
performing the calculation with an O'Rourke model when coalescence, bounce and breakup occur due to a mutual collision between the droplets.

6. The performance prediction method for a whole atomization process of an aeroengine fuel according to claim 3, further comprising:
performing, for an interaction problem between a DEM particle and an SDPH particle, the calculation with an interaction method between DEM particles.

7. A performance prediction system for a whole atomization process of an aeroengine fuel, comprising:
a three-dimensional (3D) geometric model establishment module, configured to establish a 3D geometric model for an aeroengine fuel atomizing nozzle and a spray flow field, the 3D geometric model being a mesh model;
a physical multiphase flow model establishment module, configured to establish a physical fuel-gas-droplet multiphase flow model based on the 3D geometric model, the physical fuel-gas-droplet multiphase flow model comprising a physical fuel-gas two-phase flow model, a volume of fluid (VOF) functional model for tracking a gas-liquid two-phase interface as well as surface tension and viscous force constitutive models for the fuel;
a central velocity field and fluid volume fraction distribution determination module, configured to obtain a central velocity field and a fluid volume fraction distribution of meshes with a finite volume method (FVM) based on the physical fuel-gas two-phase flow model, the VOF functional model for tracking the gas-liquid two-phase interface as well as the surface tension and viscous force constitutive models for the fuel;
a definition module, configured to define a gas and a liquid according to the central velocity field and the fluid volume fraction distribution;
a mesh refinement module, configured to perform mesh refinement on the gas-liquid two-phase interface with an orthogonal adaptive Cartesian mesh method;
a transformation module, configured to transform droplets less than a specified size in the atomization process into Lagrangian particle points; and
a calculation module, configured to perform calculation on different volume fractions for the Lagrangian particles comprised in the meshes to obtain flow field data and droplet data on different time nodes.
